(19) United States
(12) Patent Application Publication
(10) Pub. No.: US 2018/0020066 A1
(43) Pub. Date: Jan. 18, 2018

(54) GENERATING VIEWER AFFINITY SCORE IN AN ON-LINE SOCIAL NETWORK

(71) Applicant: LinkedIn Corporation, Mountain View, CA (US)

(72) Inventors: Liang Tang, Sunnyvale, CA (US); Pannagadatta K. Shivaswamy, Sunnyvale, CA (US); Nikita Igorevych Lytkin, Sunnyvale, CA (US)

(21) Appl. No.: 15/212,498

(22) Filed: Jul. 18, 2016

(51) Int. Cl. H04L 29/08; G06F 17/30; G06F 17/22; G06Q 50/00; G06F 17/21

(52) U.S. Cl. CPC H04L 67/22; G06Q 50/01; G06F 17/212; G06F 17/2247; G06F 17/3053

(57) ABSTRACT

A relevance model is used to process an inventory of updates for a member of an on-line social network in order to select a subset of updates for presentation to the member. One of the features used as input to the relevance model is viewer affinity. The viewer affinity indicates preference of a member for a particular type or source of information and is determined using the estimated probability of the member clicking on the impression of an update and also based on a correction variable. The correction variable is generated based on information regarding previously-observed interactions of the member with the updates.

### TECHNICAL FIELD

This application relates to the technical fields of software and/or hardware technology and, in one example embodiment, to system and method to generate viewer affinity score in an on-line social network.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

A member of on-line social network may be permitted to share information with other members by posting an update that would appear on respective news feed pages of the other members. An update may be an original message, a link to an on-line publication, a re-share of a post by another member, etc. Members that are presented with such an update on their news feed page may choose to indicate that they like the post, may be permitted to contribute a comment, etc.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate viewer affinity score in an on-line social network may be implemented;

FIG. 2 is block diagram of a system to generate viewer affinity score in an on-line social network, in accordance with one example embodiment;

FIG. 3 is a flow chart of a method to generate viewer affinity score in an on-line social network, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate viewer affinity score in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile of a member may also include information about the member's current and past employment, such as company identifications, professional titles held by the associated member at the respective companies, as well as the member's dates of employment at those companies. Information from the profile of a member is used to form a feature vector of the member. The feature vectors representing respective members are used in the on-line social network system, e.g., to compare member profiles to each other, to compare a member profile to other entities maintained in the on-line social network system (e.g., entities representing companies, educational institutions, job postings, etc.).

As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. When a member is connected to another member in the on-line social network system, that member's profile is associated with a link indicative of the connection, and the member receives updates regarding the other member, such as, e.g., posts shared by the other member.

An update, for the purposes of this description, is an information item for presentation to one or more members represented by respective member profiles in the on-line social network system. The updates may be presented as part of the member's so-called news feed. A news feed may be provided to a member on a dedicated web page, e.g., on a home page of the member in the on-line social network. A news feed page is generated for each member by a news feed system provided with the on-line social network system and includes items that has been determined as being potentially of interest to that member. Examples of items in the news feed generated for a member are posts and news with respect to the connections of that member and the entities that the member is following, job postings that have been determined as relevant to the member, content articles, recommendations to connect to other members (so-called PYMK or “people you may know” type of update), etc. As there may be a rather large inventory of updates available for inclusion into a member's news feed, the news feed system includes a ranking module configured to select a subset of all available updates for inclusion into the news feed. Such selection maybe based on various selection criteria, such as, e.g., the degree of relevance of an update item with respect to the member, the degree of connection between the member and the source of the update, etc. A member for whom a news feed is being generated is referred, for the purposes of this description, a focus member, and the profile representing the focus member in the on-line social network system is referred to as a focus profile.

The ranking module employs a statistical model (referred to as the relevance model for the purposes of this description) to process the inventory of updates for the focus member in order to select a subset of updates for presentation to the focus member via a news feed web page. The final set of updates is then included in the news feed web page that is being generated for the focus member. For example, in one embodiment, the ranking module ranks the items in the inventory of updates utilizing, logistic regression. The ranking module takes, as input, the attributes characterizing respective updates and the attributes characterizing the focus member. Such attributes may include the activity type associated with the item (e.g., job search if the item is job recommendation, PYMK if the item is a connection recommendation, article share if the item is news article share, etc.), focus member's past counts of interactions with items of this type, profile attributes of the focus member (e.g., skills, industry, education, etc.), as well as profile attributes of the member whose activity resulted in generation of this item (e.g., member article share), etc.

One of the features used as input to the relevance model is a so-called viewer affinity. The viewer affinity, in one embodiment, indicates the preference of a viewer (a viewer is a member of the on-line social network system) for a particular activity type. It may be referred to as the viewer-activityType affinity. For example, a member who likes to read the content articles would have a high type affinity score with respect to the article share activity type. A member who likes to connect to other members would have a high type affinity score with respect to the PYMK (people you may know) activity type. Different viewers can have the same features and yet exhibit different degrees of preference for the same activity type.

The estimated probability of a specific viewer clicking on the impression of an update of the particular activity type is determined based on the features representing the viewer (the features that form a feature vector of the viewer) and based on the features representing the activity type (the features forming the coefficient vector for the activity type). However, as the viewer features may not be enough to differentiate the viewers in practice with respect to the actual preference for various activity types, a methodology is provided to generate the viewer affinity score for a viewer by taking into consideration information regarding previously-observed interactions of the viewer with the updates of the particular activity type. In one embodiment, the viewer affinity score is generated by adjusting the estimated probability of a specific viewer clicking on the impression of an update of the particular activity type based on the information regarding previously-observed interactions of the viewer with updates of the particular activity type. The viewer affinity may be generated by the news feed system.

In operation, for a particular viewer and a particular activity type, and the news feed system first determines the estimated probability of the viewer clicking on the impression of an update of that activity type, based on the features representing the features of the activity type. The estimated probability of the viewer clicking on the impression of an update of that activity type may be referred to as the expected CTR (click through rate).

Next, the news feed system determines a so-called correction variable based on information regarding previously-observed interactions of the viewer with updates of the particular activity type. The correction variable is a random variable. The news feed system estimates posterior distribution of the correction variable based on the impression and click data with respect to the viewer and the updates of the particular activity type. As the number of observed interactions increases, the distribution function shape becomes tighter. When there are less observed interactions, the distribution function is more dispersed. The distribution gets dynamically adjusted depending of the number of recent observed interactions. “Recent” may be defined as, e.g., within a certain predetermined period of time (a week, a month, etc.).

The news feed system then estimates the affinity score with respect to the viewer and the particular activity type. The mean of the affinity score is calculated as the product of the expected CTR and the posterior mean of the correction variable. The variance of the affinity score is calculated as the product of the squared expected CTR and the posterior variance of the correction variable. As such, the viewer affinity model utilized by the news feed system is built in such a way that it estimates not only the probability of engagement of a viewer with an update of a particular activity type, but also provides a measure of uncertainty in that expectation.

Below is the description of the methodology for computing the affinity score with respect to a particular viewer and a particular activity type based on the GammaPoisson model. This model uses logistic regression to compute the prior model in the GammaPoisson model.

Let i=1, 2, . . . , denote the viewer identification (ID), j=1, 2, . . . , denote different activity types. The click count for viewer i on an update of the activity type j is a random variable and is denoted by c_{i,j}. As the click count is a count variable, the affinity model uses the Poisson distribution to model c_{i,j} as follows:

c_{i,j}˜Poisson(m_{i,j}·f(xᵢ,wⱼ)·g_{i,j}),

g_{i,j}˜Gamma(mean=1,size=1/γ),

where:

m_{i,j} is the number of impressions between the viewer and the activity type j,

f(xᵢ, wⱼ) is the prior model for calculating the probability of the viewer clicking the impression of the activity type (this probability multiplied by the number of impressions is referred to as the expected CTR),

xᵢ is the feature vector of the viewer,

wⱼ is the coefficient vector for activity type (the coefficients of the vector are also the model coefficients of the prior model),

γ is a predefined hyperparameter for the prior distribution of a random variable, which is usually set to be 1.

As m_{i,j} is the number of impressions between the viewer i and the activity type j, m_{i,j}·f(xᵢ, wⱼ) is the expected number of clicks between viewer i and the activity type j. Note that, since for a particular activity type j, wⱼ is fixed, the CTR f(xᵢ, wⱼ) is only determined by the feature vector xᵢ. However, as explained above, the viewer features may not be enough to differentiate the viewers in practice, as different viewers can have the same features with different preference for the same activity type. Therefore, we add an additional correction variable g_{i,j} into the parameter of the Poisson distribution. For different viewer and different activity type, g_{i,j} can be different. Thus, g_{i,j} is a personalized correction term and is also a random variable that can be estimated based on the observed impression and click data between the viewer i and the activity type j.

In this GammaPoisson model, there are two types of unknown variables that are estimated:

wⱼ, for i=1, 2, . . . , and

g_{i,j}, for i,j=1, 2, . . . .

In order to find the best wⱼ for a particular j and g_{i,j} for the same j, a joint optimization method may be utilized, such that the log likelihood of the Poisson model is maximized. In some embodiments, if this joint optimization is expensive (resource intensive), the affinity model may be configured to utilize a sequential optimization method, which first fixes all g_{i,j}=1 to find the best wⱼ*. Then, the affinity model fixes wⱼ=wⱼ* to find the best g_{i,j}*. This approach is termed a prior model because it only gives an initial estimation for the parameter of the Poisson model.

The process of estimating wⱼ is described below. As mentioned before, the affinity model first fixes all g_{i,j}=1, then calculates c_{i,j}˜Poisson (m_{i,j}·f(xᵢ, wⱼ)). By Poisson limit theorem, it is known that Poisson (λ)≈Bernoulli (n, λ/n) if n is large. Thus, we have c_{i,j}˜Poisson (m_{i,j}f(xᵢ, wⱼ))≈Bernoulli (m_{i,j}, f(xᵢ, wⱼ)).

Then, this is a Bernoulli process for m_{i,j} trials. Thus, we can use logistic regression to estimate the best wⱼ*, where

f(xᵢ,wⱼ)=1/(1+exp(−xᵢ^{T}wⱼ).

The best wⱼ* is the best estimation of wⱼ, wⱼ being the coefficient of a logistic regression model. The best wⱼ* is the optimal solution that maximizes the log likelihood of the logistic regression model based on the training data.

The process of estimating posterior distribution of g_{i,j} is described below. After the affinity model determines the best wⱼ* for each activity type j, it fixes wⱼ=wⱼ*. For a particular viewer i, the viewer feature vector xᵢ is also fixed. As a result, given i,j, f(xᵢ, wⱼ) is also fixed and can be seen as a constant for the random variable g_{i,j}. The number of impressions is also a constant.

In Poisson (m_{i,j}·f(xᵢ, wⱼ)·g_{i,j}), only g_{i,j} is a random variable.

Let λ_{i,j}=m_{i,j}·f(xᵢ, wⱼ)·g_{i,j}, then c_{i,j}˜Poisson (λ_{i,j}).

Based on the conjugate prior for Poisson distribution, the parameter of a Poisson distribution, λ_{i,j}, follows a Gamma distribution.

Assuming λ_{i,j}˜Gamma (α_{i,j}, β_{i,j}), g_{i,j} also follows a Gamma distribution, where

$${g}_{i , j} = \frac{{λ}_{i , j}}{{m}_{i , j} \cdot f ( {x}_{i} , {w}_{j} )} ∼ Gamma ( {α}_{i , j} , {β}_{i , j} \cdot {m}_{i , j} \cdot f ( {x}_{i} , {w}_{j} ) ) .$$

Thus, g_{i,j} can be defined the as a Gamma random variable.

As stated above, the predefined prior of g_{i,j} is Gamma (mean=1, size=1/γ),

Thus,

$$mean = \frac{{α}_{i , j}}{{β}_{i , j} \cdot {m}_{i , j} \cdot f ( {x}_{i} , {w}_{j} )} = 1$$

$$size = \frac{1}{{β}_{i , j} \cdot {m}_{i , j} \cdot f ( {x}_{i} , {w}_{j} )} = 1 / γ \\ = > \\ {α}_{i , j} = γ$$

$${β}_{i , j} = \frac{γ}{{m}_{i , j} \cdot f ( {x}_{i} , {w}_{j} )}$$

Let y_{i,j} be the observed number of clicks of viewer i on the activity type j. Since the Gamma distribution is the conjugate prior of Poisson distribution, the posterior distribution of λ_{i,j} is Gamma (α_{i,j}+y_{i,j}, β_{i,j}+1).

Accordingly, the posterior distribution of g_{i,j} is:

Gamma(α_{i,j}+y_{i,j},(β_{i,j}+1)·m_{i,j}·f(xᵢ,wⱼ)).

Then, the mean of g_{i,j} is:

$$\frac{{α}_{i , j} + {γ}_{i , j}}{( {β}_{i , j} + 1 ) \cdot {m}_{i , j} \cdot f ( {x}_{i} , {w}_{j} )} .$$

By substituting α_{i,j} and β_{i,j}, the posterior mean of g_{i,j} is:

$${\hat{g}}_{i , j} = \frac{γ + {y}_{i , j}}{( \frac{γ}{{m}_{i , j} \cdot f ( {x}_{i} , {w}_{j} )} + 1 ) \cdot {m}_{i , j} \cdot f ( {x}_{i} , {w}_{j} )} = \frac{γ + {y}_{i , j}}{γ + {m}_{i , j} \cdot f ( {x}_{i} , {w}_{j} )}$$

The posterior variance of g_{i,j} is

$${σ}_{{g}_{i , j}}^{2} = \frac{γ + {y}_{i , j}}{{( γ + {m}_{i , j} \cdot f ( {x}_{i} , {w}_{j} ) )}^{2}} .$$

The process of estimating the affinity score is described below. The final affinity score for viewer i and activity type j is the expected CTR multiplied by the posterior of the correction term g_{i,j}. Given the, the i and j, the expected CTR is a constant.

Since the posterior of g_{i,j}˜Gamma (α_{i,j}+y_{i,j}, (β_{i,j}+1)·m_{i,j}·f(xᵢ, wⱼ)), the affinity score is also a Gamma random variable of Gamma (α_{i,j}+y_{i,j}, β_{i,j}+1)·m_{i,j}).

The mean of the affinity score is:

$$\frac{γ + {y}_{i , j}}{( \frac{γ}{{m}_{i , j} \cdot f ( {x}_{i} , {w}_{j} )} + 1 ) \cdot {m}_{i , j}} = f ( {x}_{i} , {w}_{j} ) \cdot {\hat{g}}_{i , j} = f ( {x}_{i} , {w}_{j} ) \cdot \frac{γ + {y}_{i , j}}{γ + {m}_{i , j} \cdot f ( {x}_{i} , {w}_{j} )} .$$

The variance of the affinity score is:

$$\frac{γ + {y}_{i , j}}{{( \frac{γ}{{m}_{i , j} \cdot f ( {x}_{i} , {w}_{j} )} + 1 )}^{2} \cdot {m}_{i , j}^{2}} = {f ( {x}_{i} , {w}_{j} )}^{2} \cdot {σ}_{{g}_{i , j}}^{2} = {f ( {x}_{i} , {w}_{j} )}^{2} \cdot \frac{γ + {y}_{i , j}}{{( γ + {m}_{i , j} \cdot f ( {x}_{i} , {w}_{j} ) )}^{2}} .$$

The affinity score may be used as input into the ranker, as mentioned above, as well as, e.g., in relevance-based section ordering for network updates digest emails.

In some embodiments, the news feed system is configured to calculate, for a viewer, the affinity score that indicates the preference of the viewer for updates that originate from a particular member of the on-line social network system. Such affinity score may be referred to as a viewer-actor affinity. The viewer is a member for whom the feed is being generated. The actor is a member that originated an update. The affinity score generated using the methodology described above may reveal that a viewer has a high affinity score with respect to one member and a lower affinity score with respect to another member even though the profile of the first member is more similar to the profile of the viewer than the profile of the second member.

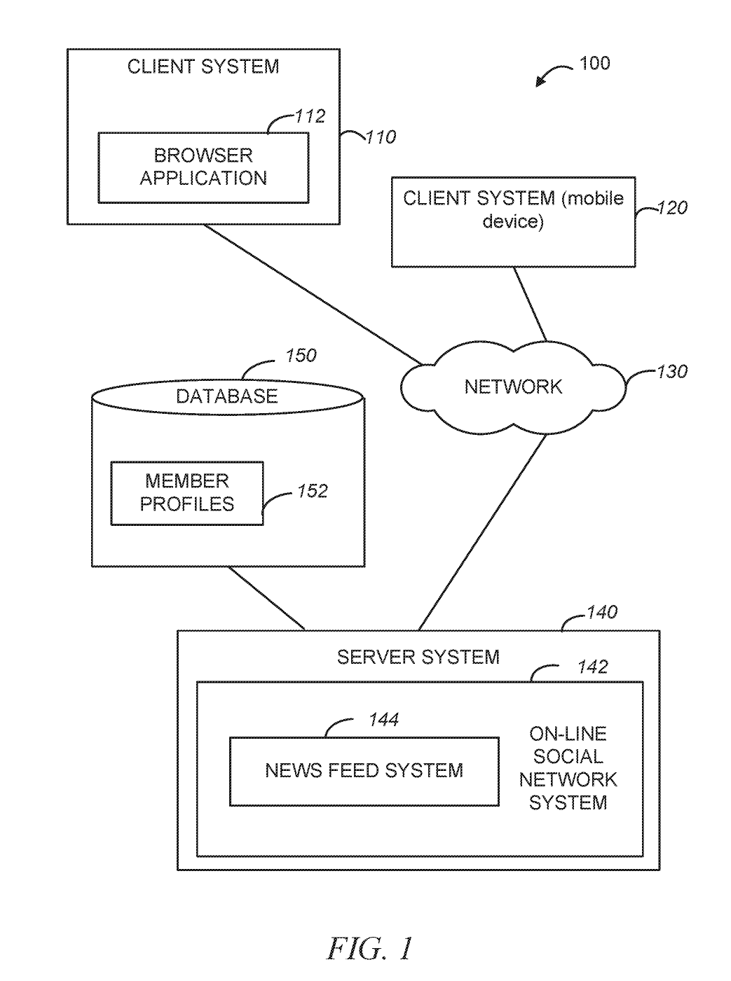

Example method and system to generate viewer affinity score in an on-line social network may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

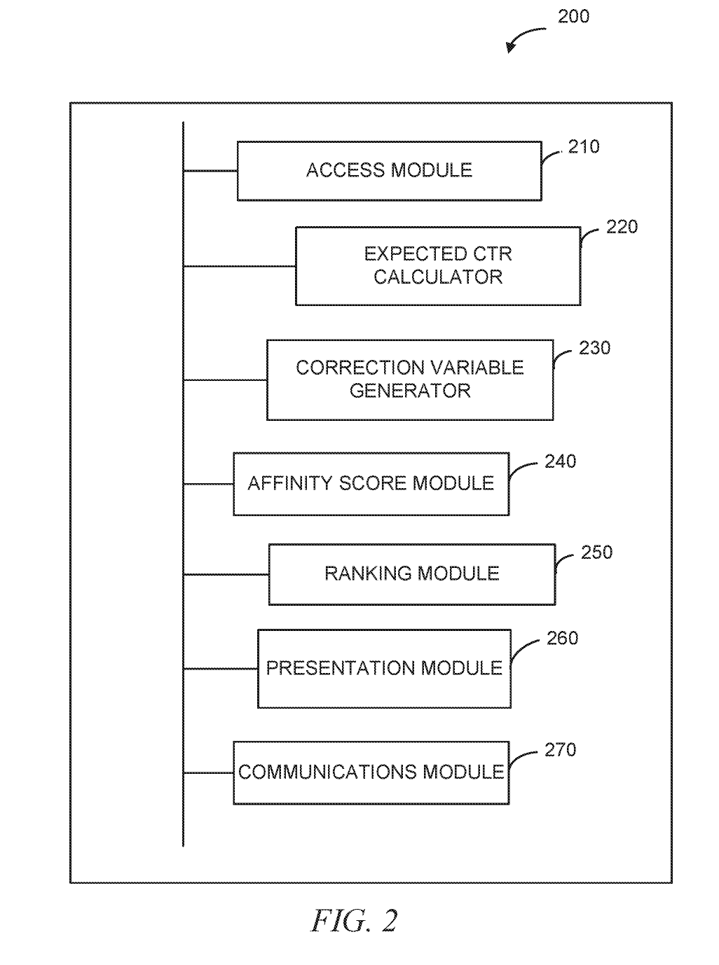

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a news feed system 144 that may be utilized beneficially to determine respective success scores for higher education institutions referred to as schools for the sake of brevity. The news feed system 144 may be configured to process an inventory of updates for a member of an on-line social network, employing a relevance model, in order to select a subset of updates for presentation to the member, using the methodologies described above. As already explained, one of the features used as input to the relevance model is viewer affinity. The viewer affinity indicates preference of a member for a particular type or source of information and is determined using the estimated probability of the member clicking on the impression of an update and also based on a correction variable. The correction variable is generated based on information regarding previously-observed interactions of the member with the updates. An example news feed system 144 is illustrated in FIG. 2.

FIG. 2 is a block diagram of a system 200 to generate viewer affinity score in an on-line social network, in accordance with one example embodiment. As shown in FIG. 2, the system 200 includes an access module 210, an expected CTR calculator 220, a correction variable generator 230, and an affinity score module 240, and a ranking module 250. The expected CTR calculator 220, the correction variable generator 230, and the affinity score module 240 employ the affinity model described above.

The access module 210 is configured to access a focus profile representing a member in the on-line social network system 142 of FIG. 1. The focus profile includes profile features that are indicative of the member's professional skills, experience, seniority, connections within the on-line social network system 142, etc.

The expected CTR calculator 220 is configured to calculate expected click through rate (CTR) with respect to the focus profile and an activity type. An activity type represents an activity within the on-line social network system 142, such as viewing content articles, connecting to other members, viewing updates generated by a particular member, etc. An activity type is represented by a coefficient vector. The expected CTR calculator 220 uses the profile features of the focus member and the coefficient vector of the activity type that is the subject of the inquiry (referred to as the certain activity) to calculate the expected CTR. In one embodiment, the expected CTR calculator 220 uses logistic regression to select one coefficient from the coefficient vector and then uses the selected coefficient (designated as wⱼ* in the description above) for calculating the expected CTR.

The correction variable generator 230 is configured to access information regarding previously-observed interactions of the focus member with updates of that certain activity type and generate posterior distribution of a correction variable based on the observed data. As explained above, the correction variable is a random variable. The correction variable generator 230 estimates posterior distribution of the correction variable based on the impression and click data with respect to the viewer and the updates of the particular activity type. The impression and click data includes a value indicating a number of times an update of the certain activity type was presented to the member and a number of times the member clicked on any of the updates of the certain activity type that were presented to the member. The correction variable generator 230 monitors activity of the member in the on-line social network system 142 with respect to updates of the certain activity type and generates the observed data based on the monitoring. In some embodiments, the correction variable generator 230 accesses the observed data that was previously collected and stored by another module. The generating of the observed data based on the monitoring may include ignoring a portion of the observed data associated with a period of time that is greater than a predetermined recent period of time (e.g., ignoring data that is older than 30 days).

The affinity score module 240 is configured to calculate affinity score for the focus profile with respect to the certain activity type using the posterior distribution of the correction variable, using the methodology described above. The mean of the affinity score may be calculated as the product of the expected CTR and the posterior mean of the correction variable. The variance of the affinity score may be calculated as the product of the squared expected CTR and the posterior variance of the correction variable.

The ranking module 250 is configured to use the affinity score as input to generate respective ranks for items in an inventory of updates identified as potentially of interest to the member and to select a subset of items from the inventory based on the generated respective ranks.

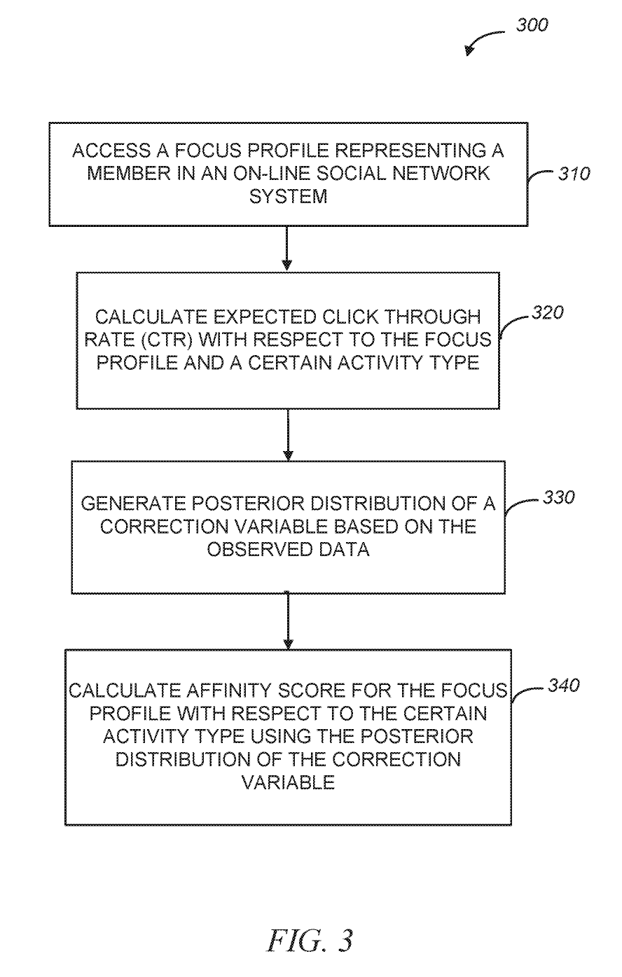

The presentation module 260 is configured to construct a news feed web page that includes the subset of items from the inventory and to cause presentation of the news feed web page on a display device of the member (e.g., on the display device of the client system 110 of FIG. 1). The presentation module 260 may also be configured to prepare an electronic communication for the member (e.g., an email) that includes the subset of items from the inventory. The communications module 270 is configured to transmit the electronic communication to a computer device of the member (e.g., to the client system 110 of FIG. 1). Some operations performed by the system 200 may be described with reference to FIG. 3.

FIG. 3 is a flow chart of a method 300 to generate viewer affinity score in an on-line social network for a member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 of FIG. 2 accesses a focus profile representing a member in the on-line social network system 142 of FIG. 1. The expected CTR calculator 220 calculates the expected CTR with respect to the focus profile and an activity type at operation 320. The correction variable generator 230 generates, at operation 330, posterior distribution of a correction variable based on the observed data reflecting the impressions and clicks with respect to the viewer and the updates of the particular activity type. The affinity score module 240 calculates affinity score for the focus profile with respect to the certain activity type using the posterior distribution of the correction variable, at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

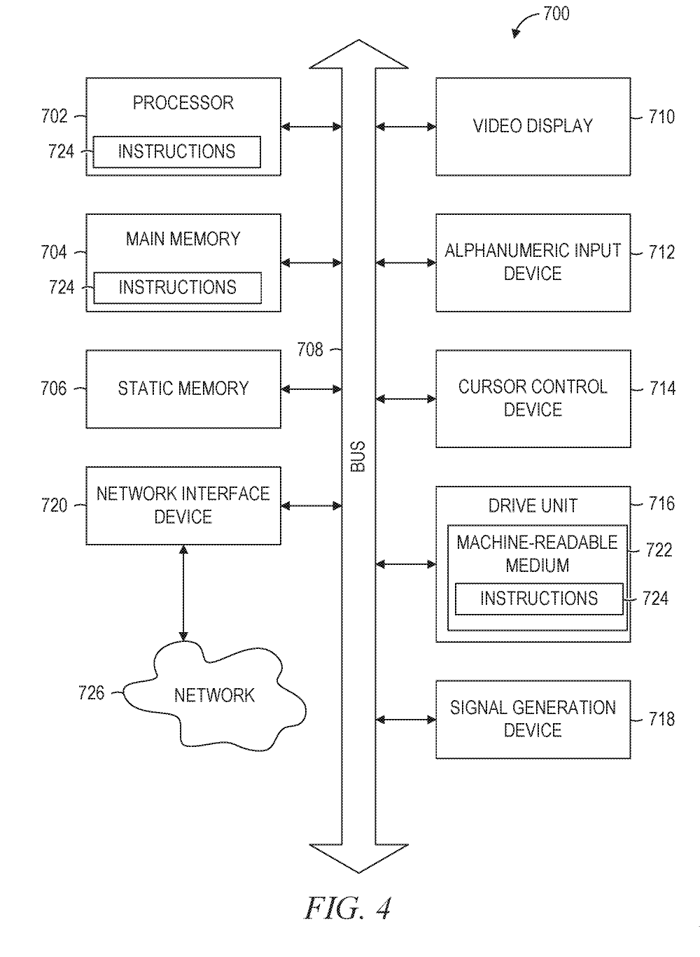

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to generate viewer affinity score in an on-line social network have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a focus profile representing a member in an on-line social network system, the focus profile comprising profile features;
calculating expected click through rate (CTR) with respect to the focus profile and a certain activity type, the certain activity type represented by a coefficient vector, using the profile features and the coefficient vector;
accessing observed data including a value indicating a number of times an update of the certain activity type was presented to the member and a number of times the member clicked on any of the updates of the certain activity type that were presented to the member;
generating posterior distribution of a correction variable based on the observed data; and
using at least one processor, calculating affinity score for the focus profile with respect to the certain activity type using the posterior distribution of the correction variable.

2. The method of claim 1, comprising using the affinity score as input into a ranking module, the ranking module to generate respective ranks for items in an inventory of updates identified as potentially of interest to the member and to select a subset of items from the inventory based on the generated respective ranks.

3. The method of claim 2, comprising:
constructing a news feed web page that includes the subset of items from the inventory; and
causing presentation of the news feed web page on a display device of the member.

4. The method of claim 1, comprising:
calculating the mean of the affinity score as the product of the expected CTR and the posterior mean of the correction variable; and
calculating the variance of the affinity score as the product of the squared expected CTR and the posterior variance of the correction variable.

5. The method of claim 1, wherein the calculating of the expected CTR comprises using logistic regression to select one coefficient from the coefficient vector and using the one coefficient for calculating the expected CTR.

6. The method of claim 1, comprising:
monitoring activity of the member in the on-line social network system with respect to updates of the certain activity type; and
generating the observed data based on the monitoring.

7. The method of claim 6, wherein the generating of the observed data based on the monitoring comprises ignoring a portion of the observed data associated with a period of time that is greater than a predetermined recent period of time.

8. The method of claim 1, wherein the certain activity type is related to connecting with other members in the on-line social network system.

9. The method of claim 1, wherein the certain activity type is related to updates generated by another specific member in the on-line social network system.

10. The method of claim 1, comprising:
using the affinity score to generate respective ranks for items in an inventory of updates identified as potentially of interest to the member and to select a subset of items from the inventory based on the generated respective ranks;
preparing an electronic communication for the member, the electronic communication includes the subset of items from the inventory; and
transmitting the electronic communication to a computer device of the member.

11. A computer-implemented system comprising:
an access module, implemented using at least one processor, to access a focus profile representing a member in an on-line social network system, the focus profile comprising profile features;
an expected CTR calculator, implemented using at least one processor, to calculate expected click through rate (CTR) with respect to the focus profile and a certain activity type, the certain activity type represented by a coefficient vector, using the profile features and the coefficient vector;
a correction variable generator, implemented using at least one processor, to:
access observed data including a value indicating a number of times an update of the certain activity type was presented to the member and a number of times the member clicked on any of the updates of the certain activity type that were presented to the member, and
generate posterior distribution of a correction variable based on the observed data; and
an affinity score module, implemented using at least one processor, to calculate affinity score for the focus profile with respect to the certain activity type using the posterior distribution of the correction variable.

12. The system of claim 11, comprising a ranking module, implemented using at least one processor, to take the affinity score as input, the ranking module to generate respective ranks for items in an inventory of updates identified as potentially of interest to the member and to select a subset of items from the inventory based on the generated respective ranks.

13. The system of claim 12, comprising a presentation module, implemented using at least one processor, to:
construct a news feed web page that includes the subset of items from the inventory; and
cause presentation of the news feed web page on a display device of the member.

14. The system of claim 11, wherein the affinity score module is to:
calculate the mean of the affinity score as the product of the expected CTR and the posterior mean of the correction variable; and
calculate the variance of the affinity score as the product of the squared expected CTR and the posterior variance of the correction variable.

15. The system of claim 11, wherein the calculating of the expected CTR comprises using logistic regression to select one coefficient from the coefficient vector and using the one coefficient for calculating the expected CTR.

16. The system of claim 11, wherein the correction variable generator is to:
monitor activity of the member in the on-line social network system with respect to updates of the certain activity type; and
generate the observed data based on the monitoring.

17. The system of claim 16, wherein the generating of the observed data based on the monitoring comprises ignoring a portion of the observed data associated with a period of time that is greater than a predetermined recent period of time.

18. The system of claim 11, wherein the certain activity type is related to connecting with other members in the on-line social network system or related to updates generated by another specific member in the on-line social network system.

19. The system of claim 11, comprising:
a ranking module, implemented using at least one processor, to use the affinity score to generate respective ranks for items in an inventory of updates identified as potentially of interest to the member and to select a subset of items from the inventory based on the generated respective ranks;
a presentation module, implemented using at least one processor, to prepare an electronic communication for the member, the electronic communication includes the subset of items from the inventory; and
a communications module to transmit the electronic communication to a computer device of the member.

20. A machine-readable non-transitory storage medium having instruction data executable by a machine to cause the machine to perform operations comprising:
accessing a focus profile representing a member in an on-line social network system, the focus profile comprising profile features;
calculating expected click through rate (CTR) with respect to the focus profile and a certain activity type, the certain activity type represented by a coefficient vector, using the profile features and the coefficient vector;
accessing observed data including a value indicating a number of times an update of the certain activity type was presented to the member and a number of times the member clicked on any of the updates of the certain activity type that were presented to the member;
generating posterior distribution of a correction variable based on the observed data; and
calculating affinity score for the focus profile with respect to the certain
